(19) United States
(12) Patent Application Publication
(10) Pub. No.: US 2010/0038182 A1
(43) Pub. Date: Feb. 18, 2010

(54) ELEVATOR APPARATUS WITH NO MACHINE ROOM

(75) Inventors: Inaki Aranburu Agirre, Hernani (guipuzcoa) (ES); Miguel Encabo Elizondo, Hernani (guipuzcoa) (ES); Miguel Angel Madoz Michaus, Hernani (guipuzcoa) (ES); Esteban Santiago Los Arcos, Hernani (guipuzcoa) (ES)

Correspondence Address: CANTOR COLBURN, LLP, 20 Church Street, 22nd Floor, Hartford, CT, 06103, US

(73) Assignee: ORONA, S. COOP., Hernani (guipuzcoa) (ES)

(21) Appl. No.: 12/442,911

(22) PCT Filed: Sep. 24, 2007
(86) PCT No.: PCT/ES2007/000543

§ 371 Date: Mar. 25, 2009

(30) Foreign Application Priority Data
Sep. 25, 2006 (ES) P200602424

(51) Int. Cl. B66B 9/00; B66B 11/00; B66B 7/00

(52) U.S. Cl. 187/251

(57) ABSTRACT

The invention relates to an elevator apparatus with no machine room, including a drive unit (8) which actuates a drive and suspension element (5) in order to move a car between two car guides (3a, 3b) and a counterweight (2) between two counterweight guides (4a, 4b) in the elevator shaft, in which the plane formed by the two car guides (3a, 3b) is perpendicular to the plane formed by the counterweight guides (4a, 4b). A free space P′ in which the elevator handling, control and safety elements can be housed occupies approximately 40 to 60% of the upper part of the shaft corresponding to the upper vertical projection of the volume corresponding to the path of the counterweight. The remaining space contains the entire drive unit and the means for attaching said unit, including means for attaching the ends of the cables.

### FIELD OF THE INVENTION

The present invention belongs to the field of elevator apparatus with no machine room comprising a car which moves along the elevator shaft through two car guides, a counterweight which moves along the shaft through two counterweight guides, at least one drive and suspension element linked to the car and to the counterweight through deflection pulleys, a drive unit without a speed reducer located in the upper part of the shaft and a traction sheave driven by the drive unit which transmits the movement to the car and to the counterweight by means of the drive and suspension element.

### BACKGROUND OF THE INVENTION

Elevators conventionally have a room separate from the elevator shaft in which the car and the counterweight move, such that in this machine room a large part of the elevator components, such as the drive unit, safety and control devices, speed limiter, etc. . . . , are located, however the needs of architects demanding a greater use of the space of the building intended for elevator, has brought about the development of elevators with no machine room.

The emergence of elevators with no machine room has forced introducing the components which were traditionally located in the machine room into the shaft, with a tendency to leave the minimum essential components outside the shaft, usually located in the floor in a panel placed against the door frame of one of the floors of the building. This has caused elevator companies to aim their developments towards optimizing the shaft, i.e., the optimal distribution of the elevator components within the shaft and the greatest possible reduction of the space occupied by these components.

In this sense, the reduction of the space occupied by the drive unit, normally located in the upper part of the shaft, takes on great importance. One of the parameters limiting the size of the drive unit is the diameter of the traction sheave, since the standards in force establishing the safety regulations for the construction and installation of elevators (UNE-EN 81-1:1998+AC:1999) require fulfillment of the ratio: D_{SHEAVE}/D_{CABLE}≦40, where D_{SHEAVE} is the pitch diameter of the traction sheave and D_{CABLE} is the diameter of the cable, therefore considering that the minimum diameter available for the cable is 8 mm, it implies that the traction sheave must be at least 320 mm in diameter. Therefore in order to reduce the diameter of the traction sheave it is necessary to reduce the diameter of the cable. This determinant has brought about the development of cables or other systems such as belts for elevators with a reduced diameter traction sheave which maintain and/or improve the drive capacity and life.

Another determinant limiting the size of the drive unit is the required torque, such that a larger torque increases the global size of the machine. The torque is also related to the diameter of the traction sheave and increases if the latter increases.

The needs previously pointed out involved in an elevator with no machine room were initially solved with the development of drive units with a reduction through a gearbox with reduced dimensions, supported by framing and/or beams completely traversing the floor of the upper part of the shaft, being attached in the sides of the shaft such that the complete drive unit (including the traction sheave) and the entire structure which it supports occupy the upper space of the shaft.

The most recent advances for optimizing the shaft, reducing the size of the drive unit and developing cables which fulfill these features have been oriented towards using drive units without a reduction in which the engine directly drives the traction sheave, the total height of the drive unit being reduced, such that it occupies the least vertical space in the upper part of the shaft. The drive unit is located in a side volume defined in the upper part of the shaft which does not interfere with the path of the car and the path of the counterweight, and immediately above the path of the counterweight. The machine is attached on the counterweight and car guides usually through a base supporting the drive unit.

In order to be able to reduce the diameter of the traction sheave cables have been recently developed with a reduced diameter formed by high resistance steel filaments which are twisted together, forming strands, which are in turn twisted around a central core or strand, such that the cable is externally coated with a thermoplastic material providing a high coefficient of friction to contact with the groove of the traction sheave, increasing the drive capacity thereof, in addition to improving the rest of the characteristics of the life of the cable, such as resistance to fatigue, to bending, resistance to external abrasion, free of maintenance, etc. . . . As an alternative to the coated steel cables, cables formed by highly resistant and externally coated filaments have also been developed, as well as belts formed by several strands and/or parallel cables formed by externally coated steel wires or synthetic fibers having a flat cable appearance.

With this elevator configuration the total height occupied by the drive unit in the upper part of the shaft has been optimized, however upon reducing this height, the space intended for housing other elevator components in this sector has also been reduced in height.

Another known problem making the previously mentioned problem more critical is that in recent years new features and functions have been incorporated to elevators in the form of safety or control devices which need to be introduced in the shaft, preferably in the upper part of the shaft near the door of the last floor in order to make maintenance work, etc. . . . easier. All these new devices, such as for example the regulator, contactor panel, energy dissipation resistors, control panel, emergency devices, etc. . . . require a space in the shaft which can be difficult to provide with the previously mentioned elevator configurations, therefore the current space needs for these devices in the upper part of the shaft are greater.

As an example of this type of elevator configuration, patent of invention EP1577251 describes an elevator with no machine room formed by a drive unit without a speed reducer located in the upper side part of the shaft which is supported through a base on three guides (those corresponding to two counterweight guides and one car guide). This configuration has the problem that the drive unit and its base occupy most of the upper shaft greatly limiting the space available for housing other components within the shaft.

In the field of elevators it is known that any optimization of the elevator shaft, as well as the reduction of the components located within the shaft, involves a technological advancement.

### DESCRIPTION OF THE INVENTION

In order to solve the previously described problems the present invention proposes an elevator configuration optimizing the distribution, the attachment and the space occupied by the drive unit in the upper part of the elevator shaft. Likewise a base with a special configuration supporting the drive unit, and the drive unit itself, are proposed.

The invention can be applied to elevator apparatus with no machine room comprising a car which moves along the shaft through two car guides, a counterweight which moves along the shaft through two counterweight guides, at least one drive and suspension element linked to the car and to the counterweight through deflection pulleys, a drive unit without a speed reducer located in the upper side part of the shaft and a traction sheave driven by the drive unit which transmits the movement to the car and to the counterweight by means of the drive and suspension element.

This invention can likewise be applied to elevators in which the deflection pulleys of the car are below said car, as well as to the case that the car guides are perpendicular to the counterweight guides.

Each of the counterweight guides is located on sides opposite the plane formed by the car guides, which means that the counterweight can be extended with a considerable width, close to the length of the closest side wall, which implies that it can have a reduced thickness in order to achieve the same weight as other solutions. In other previous implementations the counterweights with less width require greater thicknesses and heights, which is to the detriment of the optimization of the use of the space of the shaft.

Starting from these design premises the elevator configuration proposed by this invention provides a maximum space in the upper part of the shaft for housing different components other than the drive unit, especially the control unit.

In this sense it is contemplated that the drive unit is integrally located in a first parallelepiped space located above the path of the counterweight, which is limited first of all by one of the faces of a first vertical plane, which passes through the car guide closest to the counterweight and is perpendicular to the side wall of the shaft closest to the counterweight. The control unit is located in a second parallelepiped space located above the path of the counterweight, which is limited first of all by the other face of said first vertical plane. Said first and second space are likewise limited between:

the horizontal plane passing through the upper ends of the counterweight guides,

the shaft ceiling,

the side wall of the shaft closest to the counterweight,

a second vertical plane coinciding with a plane passing through the side wall of the car closest to the counterweight or coinciding with a plane parallel to the latter which goes into the car a few millimeters, and

the front or rear walls of the shaft.

Apart from the drive unit, means for attaching the ends of the cables could likewise be included in said first space.

The positioning of the drive unit in this first space in the upper part of the shaft, as has been defined, involves the reduction of the space normally occupied by said drive unit and the existence of a larger space in this upper part of the shaft for housing the control unit.

As said first and second spaces have been defined, each of them can indistinctly correspond to the volume which is limited by the front wall of the shaft or to the volume which is limited by the rear wall of the shaft, the contiguous volume corresponding to the other space. This implies that the drive unit and the control unit are interchangeable and therefore can be housed in either side of the plane defined by the car guides.

The drive unit is supported by a base, which is preferably supported on the upper end of one of the counterweight guides and on the upper end of the car guide closest to the counterweight, a base which is likewise attached on said guides.

Unlike other solutions in which the drive unit is supported only on the counterweight guides, in this case the drive unit achieves better support conditions, since the car guide forms a more robust support than the counterweight guide. The support on these two points likewise allows obtaining a reduction of the space occupied by the drive unit above the path of the counterweight, since upon being supported only on these two guides, and not on three guides, the occupation of the space of the drive unit is limited to one side of the car guides, leaving the previously described second space for the installation of the control unit.

The base supporting the drive unit has a maximum length LB in millimeters fulfilling the ratio:

L_{B}≦L_{FH}/2+K

where L_{FH} is the length in millimeters of the side wall of the shaft and K is the distance in millimeters between the middle plane of the traction sheave and the vertical plane formed by the two car guides, wherein K is a constant value comprised between 50≦K≦1500, preferably comprised between 100≦K≦400.

The base generally has a first vertical plate which can be coupled to the car guide closest to the counterweight and a second vertical plate which can be coupled to one of the counterweight guides, which vertical plates are perpendicular to one another and which are joined by a first horizontal plate in which the drive unit is located.

Anti-vibration insulation means can be assembled between the base supporting the drive unit and the drive unit itself.

It must also be pointed out that the base supporting the drive unit could have a connection with a close wall of the shaft, thus preventing the possible movement in the horizontal plane of the drive unit which could be caused by vibrations during its operation and that this connection is sliding vertically with said wall of the shaft. The connection therefore prevents the horizontal movement but allows the vertical movement for absorbing expansions and/or shortenings of the length of the guides, caused for example by temperature changes, especially in panoramic elevators in which light enters the shaft.

In a possible embodiment the base complementarily has a second horizontal plate separated in height from the first horizontal plate, in which the ends of the drive and suspension elements can be attached by means of their terminals. In the case of not having this second horizontal plate, these drive and suspension elements can be attached to the first horizontal plate.

The possibility that blocks adapting the final height of the base can be incorporated between the base and at least one of the upper ends of one of the counterweights guides or of the car guide closest to the counterweight guides is likewise considered.

With regard to the drive unit used in the elevator, it must be pointed out that the arrangement thereof is such that the shaft of the traction sheave and the shaft of the engine of the drive unit are arranged parallel to the side wall of the shaft closest to the counterweight.

The engine of the drive unit can be longitudinally modular depending on the necessary torque requirements for the installation, keeping the section constant, its size therefore being adaptable within the space of the elevator shaft provided for same.

The drive unit lacks a speed reducer and comprises an engine and a traction sheave integral with a shaft which is supported on a rear support and on a front support by means of bearings.

The shaft of the engine has brakes with reduced dimensions which are integrated as a continuation of the drive unit, arranged such that their plan projection does not project from the sides of the drive unit and preferably consist of a disk assembled on the shaft of the engine on which pads arranged radial to the shaft act, which can be moved towards the rear support when reels in the brake position are activated, causing the thrust of the pads against the disk and in turn of the disk on said rear support.

The incorporation of these types of brakes contributes to reducing the length of the drive unit in relation to other conventional solutions in which the drive unit has contiguous axial brakes.

The geometry of the space provided for the drive unit likewise contributes to the reduction thereof. On one hand the pitch diameter of the traction sheave is less than or equal to 200 mm and on the other hand the drive unit and the engine have a width less than or equal to 300 mm.

### BRIEF DESCRIPTION OF THE FIGURES

To complement the description being made and for the purpose of aiding to better understand the features of the invention according to a preferred practical embodiment thereof, a set of drawings is attached as an integral part of said description, in which the following has been shown with an illustrative and non-limiting character:

FIG. 1 shows an elevational view of the elevator object of this invention showing the particular distribution of its constitutive elements and the parallelepiped-shaped free space P′ being defined in the upper part of the elevator shaft for the possible incorporation of elevator handling, control and safety elements.

FIG. 2 shows a sectional plan view of the elevator depicting with dotted lines the deflection pulleys of the car for an inclined distribution thereof according to an angle θ with respect to the front or rear walls, in which the first space P and the second space P′ in which the drive unit and the control unit, respectively, are housed can also be observed.

FIG. 3 shows a sectional plan view of the elevator depicting with dotted lines the deflection pulleys of the car for a parallel distribution thereof with respect to the front or rear walls.

FIG. 4 shows a schematic view in which the planes between which the first and second space P, P′ are defined have been depicted.

FIG. 5 shows a perspective view of a first embodiment of the base supporting the drive unit.

FIG. 6 shows a perspective view of a second embodiment of the base supporting the drive unit in a position prior to its coupling on one of the counterweight guides and on the car guide closest to the counterweight guides.

FIG. 7 shows a detailed view in which the connection sliding vertically between the base and a close wall is shown.

FIG. 8 shows a schematic view of the drive unit in which the brake is likewise shown.

### DETAILED DESCRIPTION OF THE PREFERRED EMBODIMENTS

In view of the figures a preferred embodiment of the elevator with no machine room, object of this invention, is described below.

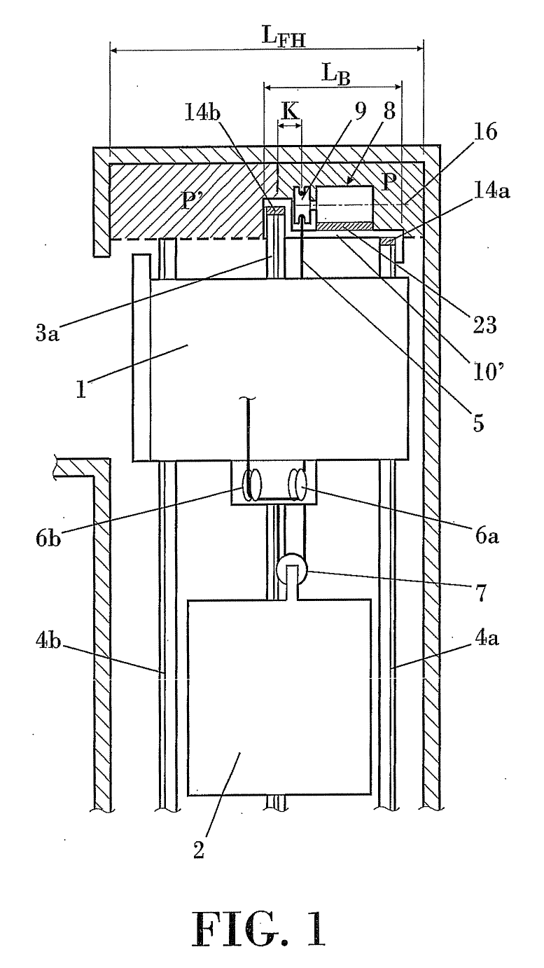

FIG. 1 shows the elevator shaft in which the car (1) moves between two car guides (3a, 3b) and its counterweight (2) between two counterweight guides (4a, 4b), due to the action of a drive unit (8) located in the upper part of the shaft above the path of the counterweight (2).

The drive unit (8) has a traction sheave (9) which transmits the movement to the car (1) and counterweight (2) by means of a drive and suspension element (5) linked to the car (1) and counterweight (2) by deflection pulleys (6a, 6b, 7).

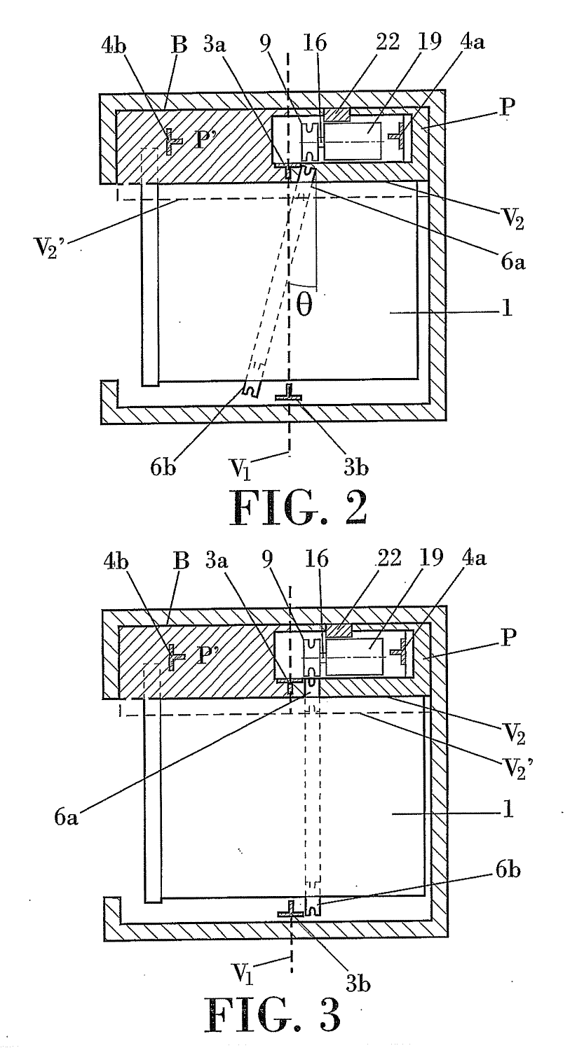

FIG. 3 shows the deflection pulleys of the car (6a, 6b) below this car (1), both located in a plane parallel to the front or rear walls of the elevator shaft and FIG. 2 shows another possible solution in which the plane formed by the deflection pulleys of the car (6a, 6b) forms an angle θ with said front or rear walls.

FIGS. 2 and 3 show that the plane formed by the car guides (3a, 3b) is perpendicular to the plane formed by the counterweight guides (4a, 4b) and that each of the counterweight guides (4a, 4b) is located on sides opposite to the plane formed by the car guides (3a, 3b).

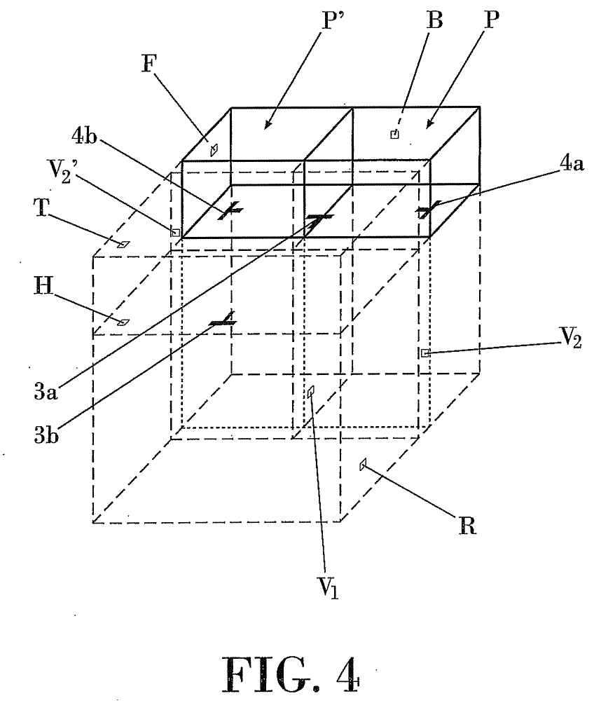

Taking FIGS. 1 to 4 as a reference it can be observed that the drive unit (8) is integrally located in a first parallelepiped space (P) located above the path of the counterweight (2), limited first of all by one of the faces of a first vertical plane (V1), as shown in FIG. 4, which passes through the car guide (3a) closest to the counterweight (2) and is perpendicular to the side wall (B) of the shaft closest to the counterweight (2), and that the control unit of the elevator, not depicted, is located in a second parallelepiped space (P′) located above the path of the counterweight (2), limited first of all by the other face of said first vertical plane (V1), in which said first and second space (P, P′) are likewise limited by:

the horizontal plane (H) passing through the upper ends of the counterweight guides (4a, 4b),

the shaft ceiling (T),

the side wall (B) of the shaft closest to the counterweight (2),

a second vertical plane (V2, V2′) coinciding with the plane of the side wall of the car (V2) closest to the counterweight (2) or with a plane (V2′) parallel to the latter which goes into the car a few millimeters, and

the front (F) or rear (R) walls of the shaft.

According to this definition P and P′ could correspond to the spaces depicted in FIGS. 1 to 4 or be interchanged and adopt the position of the other, which implies the possible housing of the drive unit (8), and therefore of the control unit, on either side of the first vertical plane (V1).

As depicted in FIGS. 1 to 3, the drive unit (8) is supported with the intermediation of a base (10, 10′), on one of the counterweight guides (4a) and on the car guide (3a) closest to the counterweight (2) to which said base (10, 10′) is attached.

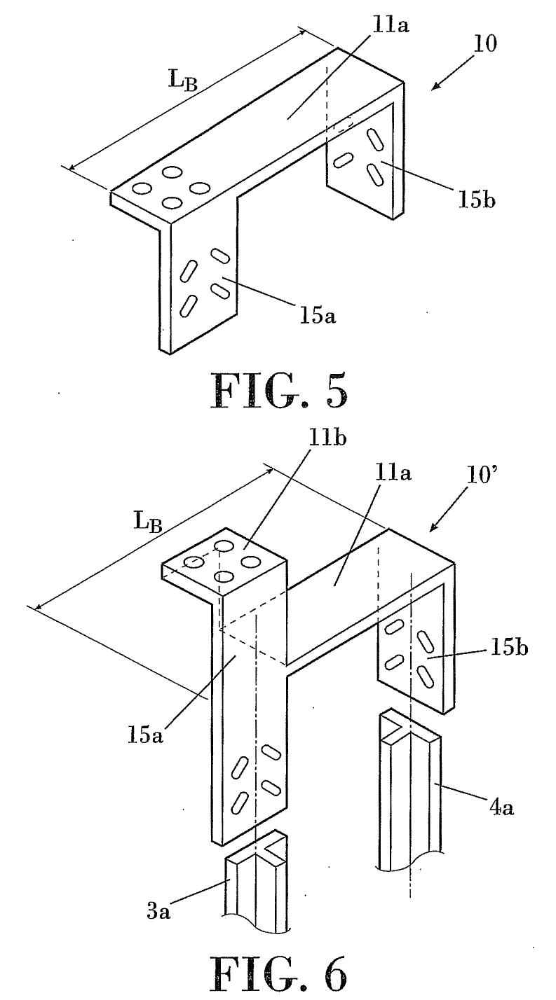

FIGS. 5 and 6 depict two possible embodiments of the base (10, 10′) having in common the incorporation of a first vertical plate (15a) which can be coupled to the car guide (3a) closest to the counterweight (2), a second vertical plate (15b) perpendicular to the first vertical plate (15a), which can be coupled to one of the counterweight guides (4a), and separated from the first vertical plate (15a) by means of a first horizontal plate (11a) in which the drive unit (8) is coupled.

In a first embodiment, depicted in FIG. 5, the base (10) incorporates the vertical plates (15a, 15b) located below the first horizontal plate (11a) and in a second embodiment, depicted in FIG. 6, the base (10′) has the first vertical plate (15a) and the second vertical plate (15b) located on both sides of the first horizontal plate (11a) and additionally incorporates a second horizontal plate (11b) which is extended from the first vertical plate (15a) to which the drive and suspension elements (5) can be attached.

FIG. 1 shows that blocks (14a, 14b) defining the position in height of the base (10, 10′) and therefore of the drive unit (8) can be arranged on one of the counterweight guides (4a) and on the car guide (3a) closest to the counterweight (2).

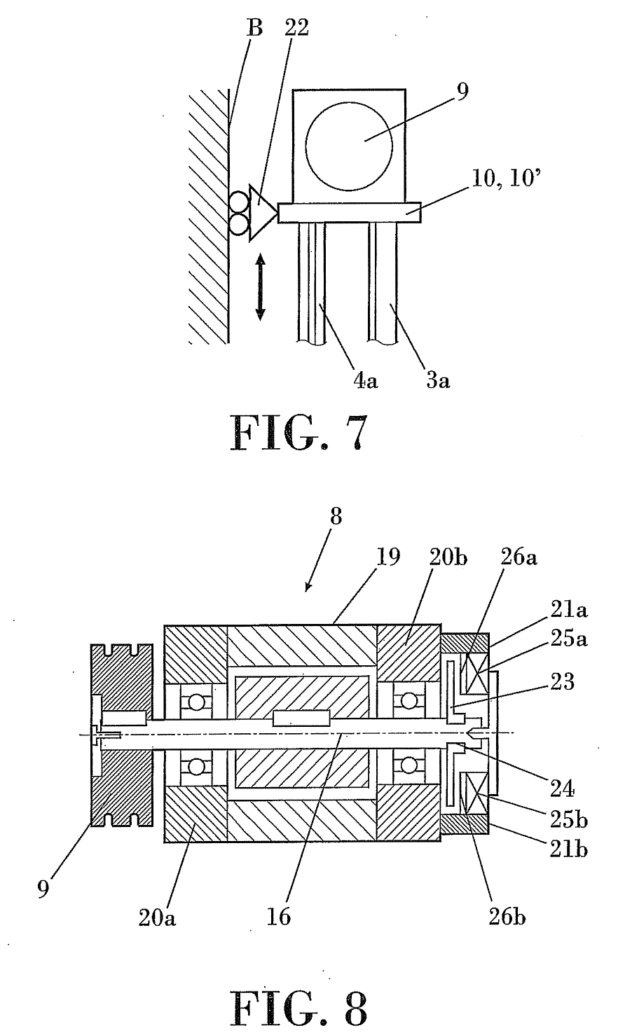

FIG. 7 depicts the drive unit (8) showing the traction sheave (9), as well as the engine (19) supported on a front support (20a) and a rear support (20b), incorporating a shaft (16) in which a disk (23) is assembled on which disk pads (26a, 26b) arranged radial to the shaft (16) act, which pads can be moved towards the rear support (20b) when reels (25a, 25b) in the brake position are activated causing the thrust of the disk (23) on said rear support (20b).

FIGS. 2 and 3 show the shaft (16) of the engine (19), which in this case likewise forms the shaft of the traction sheave (9), is arranged parallel to the side wall (B) of the shaft closest to the counterweight (2).

Likewise, said FIGS. 2 and 3 show a connection (22) sliding vertically with the side wall (B) of the shaft associated to the base (10, 10′).

The incorporation of anti-vibration insulation means (23), depicted in FIG. 1, which are located between the base (10, 10′) and the drive unit (8), is likewise contemplated.

1. Elevator apparatus with no machine room comprising:
a car which moves in an elevator shaft between two car guides, a counterweight which moves in the elevator shaft between two counterweight guides, wherein a plane formed by the two car guides is perpendicular to a plane formed by the two counterweight guides, and wherein each of the counterweight guides is respectively located on opposite sides of the plane formed by the car guides,
at least one drive and suspension element linked to the counterweight through a deflection pulley and to a car by means of deflection pulleys located below the car,
a drive unit, located in an upper part of the elevator shaft above a path of the counterweight,
a traction sheave, driven by a drive unit, which transmits movement to the car and to the counterweight by means of the drive and suspension element, and
a base supporting the drive unit,
wherein
the drive unit is integrally located in a first parallelepiped space limited first of all by a face of a first vertical plane, which passes through a car guide closest to the counterweight and is perpendicular to a side wall of the shaft closest to the counterweight, and
wherein there is a second parallelepiped space located above the path of the counterweight limited first of all by an other face of said first vertical plane, wherein said first and second parallelepiped spaces are likewise limited by:
a horizontal plane passing through upper ends of the counterweight guides,
a shaft ceiling,
the side wall of the shaft closest to the counterweight,
a second vertical plane coinciding with a plane of a side wall of the car closest to the counterweight or with a plane parallel to the plane of the side wall of the car closest to the counterweight which goes into the car a few millimeters, and
a front or rear walls of the shaft,
wherein
the drive unit consists of an engine, without a speed reducer, and in that
a control unit of the elevator is in said second parallelepiped space, and in that
the base is supported and attached on one of the counterweight guides and on the car guide closest to the counterweight, and in that
said base has a maximum length L_{B} in millimeters fulfilling the ratio:
L_{B}≦L_{FH}/2+K
where L_{FH} is a length in millimeters of the side wall of the shaft and K is a distance in millimeters between a middle plane of the traction sheave and a vertical plane formed by the two car guides, wherein K is a constant value between 50 and 1500.

2. Elevator apparatus with no machine room according to claim 1, wherein the apparatus has a connection sliding vertically between the base and one of the walls of the shaft.

3. Elevator apparatus with no machine room according to claim 1, wherein the base incorporates a first vertical plate which can be coupled to the car guide closest to the counterweight, and a second vertical plate, perpendicular to the first vertical plate, which can be coupled to one of the counterweight guides and separated from the first vertical plate by means of a first horizontal plate in which the drive unit is assembled.

4. Elevator apparatus with no machine room according to claim 3, wherein the first and second vertical plates are extended below the first horizontal plate.

5. Elevator apparatus with no machine room according to claim 3, wherein the base has the first vertical plate and the second vertical plate located on both sides of the first horizontal plate and additionally incorporates a second horizontal plate which is extended from the first vertical plate to which the drive and suspension elements can be attached.

6. Elevator apparatus with no machine room according to claim 1, wherein the constant K is between 100 and 400.

7. Elevator apparatus with no machine room according to claim 1, wherein the apparatus incorporates blocks on one of the counterweight guides and on the car guide closest to the counterweight and below the base defining a position in height of the drive unit.

8. Elevator apparatus with no machine room according to claim 1, wherein shafts of the engine and of the traction sheave are parallel to the side wall of the shaft closest to the counterweight.

9. Elevator apparatus with no machine room according to claim 8, wherein the apparatus incorporates brakes integrated after the drive unit, arranged such that the brakes plan projection does not project from the sides of the drive unit.

10. Elevator apparatus with no machine room according to claim 9, wherein the brakes consist of a disk and pads arranged radial to the shaft which can be moved towards a rear support in which the pads are assembled, and reels which after activating the brake cause a thrust of the pads on the disk and a thrust of the disk on said rear support.

11. Elevator apparatus with no machine room according to claim 8, wherein the drive unit and the engine have a width less than or equal to ≦300 mm.

12. Elevator apparatus with no machine room according to claim 8, wherein the traction sheave has a pitch diameter less than or equal to 200 mm.
